(19) United States
(12) Patent Application Publication
(10) Pub. No.: US 2013/0204758 A1
(43) Pub. Date: Aug. 8, 2013

(54) Novel tax simplification table product for tax rate and tax calculations

(71) Applicants: John H. Lee, Olathe, KS (US); Jane Q. Lee, Olathe, KS (US); Richard A. Lee, Olathe, KS (US)

(72) Inventors: John H. Lee, Olathe, KS (US); Jane Q. Lee, Olathe, KS (US); Richard A. Lee, Olathe, KS (US)

(73) Assignee: RIGEL TECHNOLOGY CORPORATION, Lenexa, KS (US)

(21) Appl. No.: 13/711,722

(22) Filed: Dec. 12, 2012

Related U.S. Application Data
(60) Provisional application No. 61/594,281, filed on Feb. 2, 2012.

(51) Int. Cl. G06Q 40/00

(52) U.S. Cl. CPC G06Q 40/103
USPC 705/31

(57) ABSTRACT

The present invention relates to a tax simplification table product to convert all Tax Table and tax calculations into the simplification table product with filing status, taxable income, tax rate formula, tax rate range check, tax rate and tax calculations together. Tax rate formulas are connected with filing statuses. A calculated tax rate is examined and compared with its correct tax rate range, which avoid or reduce calculation mistakes. Related calculations are done automatically or manually. Automatic calculations are done by a calculator or computer software product. Manual calculations are done by paper work easily. Existing Tax Tables from federal and local governments are not needed. The Tax Tables are replaced by tax rate formulas. The tax simplification table product simplifies the existing government tax systems and save time and cost significantly for individuals, corporations and governments.

### Reference Cited

U.S. Patent Documents

| | | | |
|---|---|---|---|
| 8,099,342 | Jan. 17, 2012 | Christian, et al. | 705/31 |
| 8,099,329 | Jan. 17, 2012 | Paulsen, et al. | 705/19 |
| 8,082,144 | Dec. 20, 2011 | Brown, et al. | 704/9 |
| 7,966,231 | Jun. 21, 2011 | Foster | 705/31 |
| 7,933,803 | Apr. 26, 2011 | Nadler, et al. | 705/19 |
| 7,809,614 | Oct. 5, 2010 | Von Drehnen, et al. | 705/31 |
| 6,993,502 | Jan. 31, 2006 | Gryglewicz, et al. | 705/31 |
| 3,944,801 | Mar. 16, 1976 | Montana | 705/19 |

### FIELD OF THE INVENTION

The present invention provides a tax simplification table product to convert all filing statuses, taxable incomes, tax rate formulas, tax rate range checks, tax rate and tax calculations together into the tax simplification table product. Tax rate formulas are connected with filing statuses. A calculated tax rate is examined with its correct tax rate range check, which avoids or reduces calculation mistakes. Tax rate and tax calculations are done automatically or manually. Automatic calculations are done by a calculator or computer software product. Manual calculations are done by paper work easily. Current Tax Tables from federal and state governments are not needed. The Tax Tables are replaced by tax rate formulas. The tax simplification table product simplifies the existing government tax systems and reduces processing time and cost significantly for individuals, corporations and governments.

### BACKGROUND OF THE INVENTION

In the current federal income tax systems in the United States, individual taxable income tax rates are from 10% to 35% and corporation tax rates are from 15% to 35% according to different taxable incomes. When individuals have taxable incomes not over $100,000, their tax are obtained from the Tax Tables. The Tax Table from 2011 or 2010 has 12 pages, which is long and needs people to spend more time to search. When taxable incomes are over $100,000, there are different tax computations under the four filing statuses, which are shown in Tables 1 to 4. The Tax Tables and computations in 2010 and 2011 have slight differences, which are complex and increase processing cost. If there is an income tax calculation method to combine Tax Tables and computations together simply and practically, then the income tax systems will be simplified significantly.

TABLE 1
Tax for Married couples filing jointly or Qualifying widow(er)

| Taxable income (TI) | | | Taxable income (TI) | | |
|---|---|---|---|---|---|
| Over | Not over | 2010 Tax | Over | Not over | 2011 Tax |
| 0 | 100,000 | Tax Table (12 pages) | 0 | 100,000 | Tax Table (12 pages) |
| 100,000 | 137,300 | 0.25 × TI − 7,637.50 | 100,000 | 139,350 | 0.25 × TI − 7,750 |
| 137,300 | 209,250 | 0.28 × TI − 11,756.50 | 139,350 | 212,300 | 0.28 × TI − 11,930.50 |
| 209,250 | 373,650 | 0.33 × TI − 22,219 | 212,300 | 379,150 | 0.33 × TI − 22,545.50 |
| 373,650 | | 0.35 × TI − 29,692 | 379,150 | | 0.35 × TI − 30,128.50 |

TABLE 2
Tax for Head of household

| Taxable income (TI) | | | Taxable income (TI) | | |
|---|---|---|---|---|---|
| Over | Not over | 2010 Tax | Over | Not over | 2011 Tax |
| 0 | 100,000 | Tax Table (12 pages) | 0 | 100,000 | Tax Table (12 pages) |
| 100,000 | 117,650 | 0.25 × TI − 5,152.50 | 100,000 | 119,400 | 0.25 × TI − 5,232.50 |
| 117,650 | 190,550 | 0.28 × TI − 8,682 | 119,400 | 193,350 | 0.28 × TI − 8,814.50 |
| 190,550 | 373,650 | 0.33 × TI − 18,209.50 | 193,350 | 379,150 | 0.33 × TI − 18,482 |
| 373,650 | | 0.35 × TI − 25,682.50 | 379,150 | | 0.35 × TI − 26,065 |

TABLE 3
Tax for Single

| Taxable income (TI) | | | Taxable income (TI) | | |
|---|---|---|---|---|---|
| Over | Not over | 2010 Tax | Over | Not over | 2011 Tax |
| 0 | 100,000 | Tax Table (12 pages) | 0 | 100,000 | Tax Table (12 pages) |
| 100,000 | 171,850 | 0.28 × TI − 6,290.75 | 100,000 | 174,400 | 0.28 × TI − 6,383 |
| 171,850 | 373,650 | 0.33 × TI − 14,883.25 | 174,400 | 379,150 | 0.33 × TI − 15,103 |
| 373,650 | | 0.35 × TI − 22,356.25 | 379,150 | | 0.35 × TI − 22,686 |

TABLE 4
Tax for Married couples filing separately

| Taxable income (TI) | | | Taxable income (TI) | | |
|---|---|---|---|---|---|
| Over | Not over | 2010 Tax | Over | Not over | 2011 Tax |
| 0 | 100,000 | Tax Table (12 pages) | 0 | 100,000 | Tax Table (12 pages) |
| 100,000 | 104,625 | 0.28 × TI − 5,878.25 | 100,000 | 106,150 | 0.28 × TI − 5,965.25 |
| 104,625 | 186,825 | 0.33 × TI − 11,109.50 | 106,150 | 189,575 | 0.33 × TI − 11,272.75 |
| 186,825 | | 0.35 × TI − 14,846 | 189,575 | | 0.35 × TI − 15,064.25 |

The above Tax Tables for the taxable incomes (not over $100,000) have 12 pages. Table 5 shows partial taxable income ranges and taxes under different filing statuses (2010). For single individuals (Status 3), their tax rates under taxable incomes are such as: 19.6% ($5.1), 11.8% ($51), 10.1% ($1001), 10.85% ($10,001), 17.4% ($50,001), 19.9% ($75,001), and 21.7% ($100,000). Their tax rates reduce from 19.6% at $5.1 to 10.1% at $1001 and then increase to 21.7% at $100,000, which are unreasonable. Their reasonable tax rates should be increased gradually from 10% at over $1 to 21.7% at $100,000.

TABLE 5
Federal Tax Table for Individuals (2010)

| Taxable income | | Tax | | | |
|---|---|---|---|---|---|
| Over | Not over | Status 1 | Status 2 | Status 3 | Status 4 |
| 0 | 5 | 0 | 0 | 0 | 0 |
| 5 | 15 | 1 | 1 | 1 | 1 |
| 50 | 75 | 6 | 6 | 6 | 6 |
| 1,000 | 1,025 | 101 | 101 | 101 | 101 |
| 10000 | 10050 | 1003 | 1003 | 1085 | 1085 |
| 50000 | 50050 | 6666 | 7354 | 8688 | 8688 |
| 99950 | 100000 | 17356 | 19841 | 21702 | 22115 |

2011

| | | | | | |
|---|---|---|---|---|---|
| 99950 | 100000 | 17244 | 19761 | 21610 | 22028 |

Also different states have different tax systems and calculations. Some of them use simple tax calculations with flat tax rates and others use Tax Tables for certain taxable income ranges plus different tax computations for other taxable income ranges. The tax system for individuals in Iowa is shown in Table 6 and Table 7:

TABLE 6
Iowa Tax for Individuals (2011)

Taxable income (TI)

| Over | Not over | Tax |
|---|---|---|
| 0 | 95,450 | from the Tax Tables (5 pages) |
| 95,450 | | (TI − 95425) × 0.0898 + 6846 |

TABLE 7
Iowa 1040 Tax Tables For All Filing Statuses (2011)

| | |
|---|---|
| Taxable income | Taxable income |

| Over | Not over | Tax | Over | Not over | Tax |
|---|---|---|---|---|---|
| 0 | 150 | 0 | 30,000 | 30,050 | 1489 |
| 150 | 400 | 1 | 30,050 | 30,100 | 1492 |
| 5,000 | 5,050 | 68 | 50,000 | 50,050 | 2925 |
| 10,000 | 10,050 | 278 | 70,000 | 70,050 | 4565 |
| 20,000 | 20,050 | 842 | 90,000 | 90,050 | 6361 |
| | | | 95,400 | 95,450 | 6846 |

Other countries and governments also require their citizens to pay taxes. Taxes are usually calculated and paid according to different taxable incomes and filing statuses. Flat tax rates are often used because of their simple calculations. It is better to cover different situations, in which tax rates should relate to from low to high reasonably according to taxable incomes from low to high. In some countries, incomes below to certain levels are not required to file tax returns and pay taxes because of low incomes and avoiding more calculations or paper work.

When governments spend more processing time and costs to collect and process taxes, then no more portions of taxes are used for projects and people with needs. To increase processing and operation efficiency and reduce costs are very important. More and more corporations and people like to reduce tax processing time and operation cost by simplifying current tax systems with fair tax rates, which is a hot topic in recent years. A flat tax rate is good for sale tax rate, which is operated easily. For individuals and corporations, their taxable incomes are different. One or few flat tax rates are extremely difficult to cover different situations simply. Tax Tables are usually long to cover different taxable incomes with narrow ranges. Individuals and corporations with different taxable incomes should relate to reasonable low-to-high tax rates.

We all agree to reduce our tax processing time and cost by simplifying our current tax systems for individuals, corporations, federal and state governments. Then saved costs can be used for more necessary projects and people. Also we need to provide both fair and simple tax rates.

Over the years, various attempts have been made to develop methods and apparatuses for tax calculation, computation and management. U.S. Pat. No. 8,099,342 discloses the methods, apparatus, and articles of manufacture for tax computation, management, and compliance reporting via a centralized transactional tax platform. U.S. Pat. No. 8,099,329 discloses the systems and methods for determining taxes owed for financial transactions conducted over a network. U.S. Pat. No. 8,082,144 discloses a tax calculation explanation generator. U.S. Pat. No. 7,966,231 discloses a method and system for determining taxes attributable to a financial transaction create a tax rate table. U.S. Pat. No. 7,933,803 discloses a program controlled apparatus, system, and method for determining the transactional taxes due for each item by any taxing authority worldwide. U.S. Pat. No. 7,809,614 discloses a tax transaction system, and combined sale and tax transaction systems for use in electronic commerce for the deduction of a tax, which may be a sales tax, value-added tax, or any tax on income related to a transaction or taxing event. U.S. Pat. No. 6,993,502 discloses a system and method for computing and collecting taxes, which has application for determining taxes for transactions conducted over the Internet. U.S. Pat. No. 3,944,801 discloses a method and apparatus for the exact automatic computation of sales tax rather than calculation of tax as a percentage.

The present invention discloses a practical and simple tax simplification table product to connect tax rate calculation formulas with all different filing statuses and taxable incomes. Also tax rate range check is provided to examine accuracy of calculated tax rates. No Tax Tables are needed in this invention to reduce tax processing time and costs. Related calculations can be done automatically or manually.

### SUMMARY OF THE INVENTION

This novel tax simplification table product has presented different filing statuses, taxable incomes, tax rate calculation formulas, tax rate and tax calculations, and tax rate range check together in a simple format. No Tax Tables are needed. Also a calculated tax rate is examined and compared with correct tax rate range, which avoids or reduces calculation mistakes. Related calculations are done automatically or manually. Automatic calculations are done by a calculator or computer software product. MS Excel or spreadsheet is simple format. Manual calculations are done by paper work easily. A tax rate calculation formula is used to calculate tax rate and tax under related filing status (or statuses). Existing Tax Tables from federal and state governments can be eliminated to reduce processing time and costs. Tax Tables are replaced by tax rate formulas. The tax simplification table product simplifies the existing government tax systems and save time and cost significantly for individuals, corporations and governments.

The novel tax simplification table product is presented with increasing tax rates in liner or gradual (LG) relationship as a fair format when taxable incomes increase for individuals and corporations. Tax rates change linearly and/or gradually, which are reasonable. The tax simplification table product has the following benefits: (1) Tax Tables are not needed, which are replaced by tax rate formulas. Their calculation results are compatible within minor difference range; (2) The tax rate range check provides a tool to check result accuracy, which avoids or reduces calculation mistakes; (3) The tax simplification table product reduces processing time and costs significantly and (4) All information (either for individuals or businesses or both together) may be built into their database.

Table 1 shows the existing tax system for Married couples filing jointly or Qualifying widow(er). Many individuals need to search their taxes from the 12-pages Tax Table, which is long and takes time. There is no self check for tax rate range check in existing tax systems, which may cause tax calculation mistakes. These challenges may be resolved after using the tax simplification table product in this invention. When taxable incomes are from low to high, their taxable income tax rates relate to from low to high on a linear or gradual relationship, which sounds fair and reasonable. There are two common formulas of y=a+x/b and y=c−d/x. Here a, b, c and d are constants, which can be found to match the Tax Tables or designed to certain values according to actual situations. The tax rate (y) changes against taxable income (x) linearly with the constant slope l/b in y=a+x/b or gradually with the various slopes d/x² in y=c−d/x, which are simple and practical. For married couples filing jointly or qualifying widow(er) with taxable incomes not over $100,000, tax rates can be built on a linear relationship.

Tax rate=0.1+7.363×TI×10⁻⁷=0.1+TI/1,358,142 (1)

The formula (1) is much simple to replace the 2010 Tax Table. Here 7.363×10⁻⁷ or 1/1,358,142 is from (0.17363-0.1)/100,000 to match almost all tax situations (not over $100,000) in the Tax Table (2010). Their tax rates increase linearly by timing taxable income (0 to $100,000) plus the bottom tax rate at 0.1 or 10%. When the taxable income is $100,000, then its tax rate is 17.363%. Their tax rate range check is from 0.1 to 0.174. Then Table 1 and Table 5 (2010) are converted into Table 8.

TABLE 8
Tax rate formulas for married filing
jointly or qualifying widow(er):

| Taxable income (TI) | | | |
|---|---|---|---|
| Over | Not over | Tax rate formula | (range check) |
| 0 | 100,000 | 0.1 + TI/1,358,142 | (0.1-0.174) |
| 100,000 | 137,300 | 0.25-7,637/TI | (0.173-0.195) |
| 137,301 | 209,250 | 0.28-11,756/TI | (0.194-0.214) |
| 209,251 | 373,650 | 0.33-22,219/TI | (0.213-0.271) |
| 373,650 | | 0.35-29,692/TI | (0.27-0.35) |

The tax rate differences from Tables 1&5 and Table 8 are in the range of 0 to 1% when taxable incomes are more than $100, which is shown in Table 9. When taxable incomes are less than $100, the tax rates are unreasonable high in Table 5 (from the 2010 Tax Table). Table 8 is better to replace Tables 1&5. The tax rate range check is used as a tool to check calculated tax rates within the range or not. If not, the calculations are wrong.

TABLE 9
Comparison of tax rates from the Tax Table and Formula (1)

| Taxable | From Tax Table (2010) | | | |
|---|---|---|---|---|
| Income ($) | Tax ($) | Tax rate | From Formula (1) | Difference |
| 5.1 | 1 | 19.6% | 10.0% | −9.6% |
| 25.1 | 4 | 15.9% | 10.0% | −5.9% |
| 50.1 | 6 | 12.0% | 10.0% | −2.0% |
| 100.1 | 11 | 11.0% | 10.0% | −1.0% |
| 1,000 | 101 | 10.1% | 10.1% | 0.0% |
| 10,000 | 1003 | 10.0% | 10.7% | 0.7% |
| 20,000 | 2166 | 10.8% | 11.5% | 0.7% |
| 30,000 | 3666 | 12.2% | 12.2% | 0.0% |
| 40,000 | 5166 | 12.9% | 13.0% | 0.1% |
| 50,000 | 6666 | 13.3% | 13.7% | 0.4% |
| 60,000 | 8166 | 13.6% | 14.4% | 0.8% |
| 70,000 | 9869 | 14.1% | 15.2% | 1.1% |
| 80,000 | 12396 | 15.5% | 15.9% | 0.4% |
| 90,000 | 14869 | 16.5% | 16.6% | 0.1% |
| 100,000 | 17356 | 17.4% | 17.4% | 0.0% |

When taxable incomes are from $100,000 to $373,650, the three formulas in Table 8 can be further simplified into 0.1382+TI/2,823,892 with the range check (0.173-0.271).

For other individual filing statuses of Head of Household, Single and Married Separately, similar formulas are found, which are shown in Examples 2 (2010) and 3 (2011). All calculation formulas in the tax simplification table product cover all taxable incomes under different filing statuses. Then tax filing situations are simplified. Tax rate and tax calculations can be done automatically or manually. The tax simplification will reduce tax processing time and cost significantly. Database may be built from tax collection to analyzing tax data such as total taxable incomes, average tax rate or total taxes. Similar tax simplification table products may be used by different country, state or local governments to calculate and analyze tax data for individuals and businesses. Example 1 shows the difference of the tax rate formulas between 2010 and 2011 to match their Tax Tables. Example 4 shows a state tax simplification table product, which covers all tax situations in Iowa. Example 5 shows the tax simplification table product for all tax situations in the United States.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### Example 1

### Federal Tax Table changes

The Federal Tax Tables in 2010 and 2011 (12 pages) have slight changes. Their tax rate formulas are found to match the Tax Tables, which also have slight changes and are shown in Table 10. Their filing statuses are (1) Married couples filing joint or Qualifying widow(er); (2) Head of Household (3) Single or (4) Married couple filing separately.

TABLE 10
Formulas comparison (not over $100,000) for 2010 and 2011

| Filing | Taxable income (TI) | | | |
|---|---|---|---|---|
| Status | Over | Not over | Rate Formula (2010) | Rate Formula (2011) |
| (1/1) | 0 | 100,000 | 0.1 + TI/1,358,142 | 0.1 + TI/1,380,453 |
| (2/1) | 0 | 100,000 | 0.1 + TI/1,015,486 | 0.1 + TI/1,024,485 |
| (3/1) | 0 | 60,000 | 0.1 + TI/693,642 | 0.1 + TI/701,643 |
| (3/2) | 60,000 | 100,000 | 0.1406 + TI/1,309,053 | 0.1396 + TI/1,307,770 |
| (4/1) | 0 | 70,000 | 0.1 + TI/728,191 | 0.1 + TI/737,730 |
| (4/2) | 70,000 | 100,000 | 0.1378 + TI/1,198,972 | 0.1356 + TI/1,183,236 |

For taxable income $50,001 under Married couples filing joint or Qualifying widow(er), its tax from 2010 Tax Table is $6,666 at tax rate 13.333% (6666/50001) and from 2011

Tax Table is $6,654 at tax rate 13.308% (6654/50001). The tax is reduced $12 and tax rate is reduced only 0.03%. From the formula (2010), its tax rate=0.1+50,001/1,358,142=13.682%. From the formula (2011), its tax rate=0.1+50,001/1,380,453=13.622%, which is reduced only 0.06%.

### Example 2

### Federal Tax Simplification Table Product for Individuals (2010)

All the Tax Table and calculations from Table 1 to Table 5 (2010) are converted into the tax simplification table product in Table 11, which can simplify the current individual tax system and cover all calculations for all taxable incomes under different filing statuses. The tax simplification will reduce tax processing time and cost significantly. Database may be built from collecting many individuals from Table 11.

TABLE 11
Federal tax simplification table for individuals (2010)

Filing Status: (1)Married Joint (2)Head of Household (3)Single or (4)Married Separately

| | | |
|---|---|---|
| Taxable income (TI): | Tax rate formula: | range check: |

| | | | |
|---|---|---|---|
| Name: | ID#: | Tax rate: | Tax: |

Here are all individual tax rate formulas for Filing Status (1), (2), (3) or (4):

| Filing | Taxable income (TI) | | | |
|---|---|---|---|---|
| Status | Over | Not over | Tax rate formula | (range check) |
| (1/1) | 0 | 100,000 | 0.1 + TI/1,35,8142 | (0.1-0.174) |
| (1/2) | 100,000 | 373,650 | 0.1382 + TI/2,823,892 | (0.173-0.271) |
| (1/3) | 373,650 | | 0.35-29,692/TI | (0.27-0.35) |
| (2/1) | 0 | 100,000 | 0.1 + TI/1,015,486 | (0.1-0.199) |
| (2/2) | 100,000 | 373,650 | 0.1683 + TI/3,306,266 | (0.198-0.282) |
| (2/3) | 373,650 | | 0.35-25,682/TI | (0.281-0.35) |
| (3/1) | 0 | 60,000 | 0.1 + TI/693,642 | (0.1-0.187) |
| (3/2) | 60,000 | 100,000 | 0.1406 + TI/1,309,053 | (0.186-0.218) |
| (3/3) | 100,000 | 171,850 | 0.28-6,290/TI | (0.217-0.244) |
| (3/4) | 171,850 | 373,650 | 0.33-14,883/TI | (0.243-0.291) |
| (3/5) | 373,650 | | 0.35-22,356/TI | (0.29-0.35) |
| (4/1) | 0 | 70,000 | 0.1 + TI/728,191 | (0.1-0.197) |
| (4/2) | 70,000 | 100,000 | 0.1378 + TI/1,198,972 | (0.196-0.222) |
| (4/3) | 100,000 | 104,625 | 0.28-5,878/TI | (0.221-0.224) |
| (4/4) | 104,625 | 186,825 | 0.33-11,109/TI | (0.223-0.271) |
| (4/5) | 186,825 | | 0.35-14,846/TI | (0.27-0.35) |

When a single individual has a taxable income $85,680, the tax rate formula is (3/2) 0.1406+TI/1309053 with the range check (0.186-0.218), which are connected with the taxable income. The tax rate is 0.1406+85680/1309053=20.61%, which is within the range. The tax is $17,654.53. Tax rate and tax calculations can be done automatically or manually. The tax from $85,650 to $85,700 in the 2010 Tax Table is $17,698 at 20.66%. Their tax rate difference is only −0.05% (20.61%-20.66%).

### Example 3

### Federal Tax Simplification Table Product for Individuals (2011)

The tax income ranges are designed differently from the Table 1 to Table 5 (2011). When taxable income ranges are designed to close and simple as possible, tax calculations and analysis will be much easy. Tables 12 to 14 show the new designed federal tax simplification table product for individuals to match 2011 Tax Tables and tax computation, which will reduce tax processing time and cost. Database may be built from collecting many individuals from the Tables 12 to 14.

TABLE 12
Formulas for Married Joint or Qualifying widow(er) and Head of Household

| Taxable income (TI) | | | | | |
|---|---|---|---|---|---|
| Over | Not over | Married Joint | (range check) | Head of Household | (range check) |
| 0 | 100,000 | 0.1 + TI/1,380,453 | (0.1-0.173) | 0.1 + TI/1,024,485 | (0.1-0.198) |
| 100,000 | 250,000 | 0.1275 + TI/2,226,312 | (0.172-0.240) | 0.1586 + TI/2,565,769 | (0.197-0.257) |
| 250,000 | 380,000 | 0.1805 + TI/4,213,608 | (0.239-0.271) | 0.2074 + TI/5,140,136 | (0.256-0.282) |
| 380,000 | | 0.35-30,128.5/TI | (0.27-0.35) | 0.35-26,065/TI | (0.281-0.35) |

TABLE 13
Tax simplification formulas and range check for Single

| Filing | Taxable income (TI) | | | |
|---|---|---|---|---|
| Status | Over | Not over | Tax rate formulas | (range check) |
| (3/1) | 0 | 60,000 | 0.1 + TI/701,643 | (0.1-0.186) |
| (3/2) | 60,000 | 100,000 | 0.1396 + TI/1,307,770 | (0.185-0.217) |
| (3/3) | 100,000 | 250,000 | 0.1804 + TI/2,804,367 | (0.216-0.270) |
| (3/4) | 250,000 | 380,000 | 0.2298 + TI/6,276,555 | (0.269-0.291) |
| (3/5) | 380,000 | | 0.35 × TI − 22,686 | (0.29-0.35) |

TABLE 14
Tax simplification for Married couples filing separately

| Filing | Taxable income (TI) | | | |
|---|---|---|---|---|
| Status | Over | Not over | Tax rate formulas | (range check) |
| (4/1) | 0 | 70,000 | 0.1 + TI/737,730 | (0.1-0.195) |
| (4/2) | 60,000 | 100,000 | 0.1357 + TI/1,183,236 | (0.194-0.221) |
| (4/3) | 100,000 | 150,000 | 0.1511 + TI/1,446,480 | (0.22-0.255) |
| (4/4) | 150,000 | 200,000 | 0.1953 + TI/2,521,008 | (0.254-0.275) |
| (4/5) | 200,000 | | 0.35-15,064/TI | (0.274-0.35) |

When a single individual has taxable income $180,050, its tax computation (2011) is 0.33×180050−15,103=$44,313.50 at the tax rate 24.612%. From the formula (3/3) of 0.1804+TI/2,804,367, its tax rate is 24.460%, which is within the range check, and tax is $44,040.85. Their tax rate difference is only −0.15% (24.460%-24.612%).

Besides taxable income ranges, tax rates or constants of a, b, c or d can also be designed and adjusted according to actual situations. For example a tax rate range is designed to 21.0% at taxable income $100,000 and 27.0% at $250,000 and their tax rate change linearly within the range, then their tax rate formula is 0.17+TI/2,500,000.

### Example 4

### Tax Simplification Table for Iowa Individual and Business

For a state tax filing, all individual and business data may be combined together. The Tax Tables and different tax calculations in Iowa are simplified into Table 15 with related tax rate formulas, which cover all calculations for all taxable incomes under different filing statuses. Table 6 and Table 7 (the Tax Tables) are simplified. The tax simplification will reduce tax processing time and cost.

TABLE 15
Individual and business tax simplification table for Iowa

Filing Status 1: (1) Individual or (2) Business
Filing Status 2: (2/1)Bingo . . . (2/5)Corporation . . . (2/12)Retailers . . .

| | | |
|---|---|---|
| Taxable income (TI): | Tax rate formula: | range check: |

| | | | |
|---|---|---|---|
| Name: | ID#: | Tax rate: | Tax: |

Iowa individual tax rate formulas for all filing statuses (2011) are:

| Filing | Taxable income (TI) | | | |
|---|---|---|---|---|
| Status | Over | Not over | Tax rate formula | (range check) |
| (1/1) | 0 | 20,000 | TI/470,588 | (0-0.0425) |
| (1/2) | 20,000 | 100,000 | 0.035 + TI/2,661,698 | (0.0425-0.07257) |
| (1/3) | 100,000 | | 0.0898-1,723/TI | (0.07257-0.0898) |

When an individual has a taxable income $90,050 is inputted, the tax rate formula (1/2) of 0.035+TI/2,661,698 is used with the range check (from 4.25% to 7.257%). The tax rate is 0.035+90,050/2,661,698=6.883%, which is within the range. The tax is $6,198.30. Tax rate and tax calculations can be done automatically or manually. From the Iowa Tax Tables, $90,000 to $90,050 relate to $6,361, which has the tax rate 7.067%. The tax rate difference between the two methods is only −0.18% (6.883%-7.067%). Also tax data from all individuals (and Businesses) from Table 15 may be built into their database, which may be used to be further analyzed, stored, and compared.

Iowa corporation tax rate formulas (2011) are:

| Filing | Taxable income (TI) | | | |
|---|---|---|---|---|
| Status | Over | Not over | Tax rate formula | (range check) |
| (2/5/1) | 0 | 25,000 | 0.06 | |
| (2/5/2) | 25,000 | 100,000 | 0.0-500/TI | (0.06-0.075) |
| (2/5/3) | 100,000 | 250,000 | 0.1-2500/TI | (0.075-0.09) |
| (2/5/4) | 250,000 | | 0.12-7500/TI | (0.09-0.12) |

### Example 5

### Tax Simplification Table Product for Federal and State Tax Filings

All federal and state tax filings for both individual and business in the United States are converted into the Table 16, which can simplify and unite the all government tax systems together. Under the federal or state level, there are individual or business filing statuses. Individuals have four filing statuses. Businesses have several filing statuses such Corporation, Retailer and others. Then different tax rate formulas are connected with related filing statuses according to different taxable incomes. Their database may be built from Table 16 and be stored and analyzed. The tax simplification will reduce tax processing time and cost significantly.

TABLE 16
Combined federal and state tax system for both Individual and Business

Fling Status 1: (1) Federal (2) Alabama . . . (18) Kansas . . . (51) Wyoming
Filing Status 2: (101) Individual or (102) Business
Filing Status 3: (a)Married Joint (b)Head of Household (c)Single or (d)Married Separately
Filing Status 4: (f) Cigarette Products . . . (h) Corporation . . . (p) Retailers . . .

| | | |
|---|---|---|
| Taxable income (TI): | Tax rate formula: | range check: |

| | | | |
|---|---|---|---|
| Name: | ID#: | Tax rate: | Tax: |

For (1) Federal tax rate and tax calculations, There are Individual or Business. The formulas for individual tax rate and tax calculations are shown in Examples 2 and 3. The formulas for federal business Corporation tax rate and tax calculations are as the follows:

Federal Corporation tax rate formulas (2010 and 2011):

| Filing | Taxable income (TI) | | | |
|---|---|---|---|---|
| Status | Over | Not over | Tax rate formula | (range check) |
| (1/102/h/1) | 0 | 50,000 | 0.15 | |
| (1/102/h/2) | 50,000 | 100,000 | 0.0775 + TI/68,9655 | (0.15-0.223) |
| (1/102/h/3) | 100,000 | 335,000 | 0.39-16,750/TI | (0.222-0.34) |
| (1/102/h/4) | 335,000 | 18.3 million | 0.34 + TI/1,799,833,333 | (0.34-0.35) |
| (1/102/h/5) | 18.3 million | | 0.35 | |

Corporation tax computations are the same in 2010 and 2011. When a corporation has a taxable income $185,680, the tax rate formula is (1/102/h/3) of 0.39−16,750/TI with the range check (22.2%-34%). The tax rate is 0.39−16,750/185,680=29.98%, which is within the range check. The tax is $55,665.20.

Different states or local governments may have different filing statuses and tax rate formulas. For Iowa, the tax simplification table product and tax rate formulas are shown in Example 4. For Kansas, the formulas are:

Kansas tax rate formula for Individual filing Statuses (18/101/b=c=d):

| Filing | Taxable income (TI) | | | |
|---|---|---|---|---|
| Status | Over | Not over | Tax rate formula | (range check) |
| (18/101/a/1) | 0 | 30,000 | 0.035 | |
| (18/101/a/2) | 30,000 | 60,000 | 0.0625-825/TI | (0.035-0.0488) |
| (18/101/a/3) | 60,000 | | 0.0645-945/TI | (0.0487-0.0645) |
| (18/101/b/1) | 0 | 15,000 | 0.035 | |
| (18/101/b/2) | 15,000 | 30,000 | 0.0625-415.5/TI | (0.035-0.0488) |
| (18/101/b/3) | 30,000 | | 0.0645-472.5/TI | (0.0487-0.0645) |

Kansas tax rate formula for Corporations:

| Filing | Taxable income (TI) | | | |
|---|---|---|---|---|
| Status | Over | Not over | LG Tax rate formula | (range check) |
| (18/102/h/1) | 0 | 50,000 | 0.04 | |
| (18/102/h/2) | 50,000 | | 0.07-1500/TI | (0.04-0.07) |

What is claimed is:

1. A tax simplification table product comprising filing status, taxable income, tax rate calculation formula, tax rate range check, tax rate and tax calculations, in which a filing status connects with up to fifty tax rate calculation formulas according to different taxable incomes, by the steps of (1) inputting a filing status (including sub filing statuses); (2) inputting a taxable income; (3) a tax rate calculation formula is connected with the taxable income under the filing status; (4) a tax rate range check is connected with the taxable income under the filing status; (5) the tax rate calculation formula is used to calculate a tax rate and tax automatically or manually and (6) the calculated tax rate is compared with the tax rate range check.

2. The tax simplification table product of claim 1 wherein a Tax Table to provide taxes according to taxable income ranges is not needed.

3. The tax simplification table product of claim 1 wherein the filing status may contain sub filing statuses.

4. The tax simplification table product of claim 1 wherein the tax rate calculation formulas include flat, simple or complex tax rate formulas.

5. The tax simplification table product of claim 1 wherein a tax rate range check under a certain taxable income range is provided to avoid calculation mistakes.

6. The tax simplification table product of claim 1 wherein a calculated tax rate must be within its correct tax rate range check.

7. The tax simplification table product of claim 1 wherein a tax is calculated by multiplying related calculated tax rate and taxable income.

8. The tax simplification table product of claim 1 wherein individual or business name and ID number are inputted for record and analysis purposes.

9. The tax simplification table product of claim 1 wherein data collected from the tax simplification table product is used for database and analysis.

10. A product is made on a paper product according to the tax simplification table product of claim 1.

11. A product is made in a calculator product according to the tax simplification table product of claim 1.

12. A product is made in a computer software product according to the tax simplification table product of claim 1.

13. The tax simplification table product of claim 1 wherein a database collected from the tax simplification table product is used for one or more filing statuses.

14. The tax simplification table product of claim 1 wherein a database collected from the tax simplification table product is used for a local government to make tax forms.

15. The tax simplification table product of claim 1 wherein a data collected from the tax simplification table product is used for a country to make tax forms.
